(19) United States
(12) Patent Application Publication
(10) Pub. No.: US 2019/0356877 A1
(43) Pub. Date: Nov. 21, 2019

(54) IMAGE SENSOR WITH S/H-TO-ADC VOLTAGE RANGE MATCHING

(71) Applicant: Sony Semiconductor Solutions Corporation, Kanagawa (JP)

(72) Inventors: Noam Eshel, Pardesia (IL); Golan Zeituni, Kfar-Saba (IL)

(21) Appl. No.: 16/103,030

(22) Filed: Aug. 14, 2018

Related U.S. Application Data
(60) Provisional application No. 62/672,910, filed on May 17, 2018.

(51) Int. Cl. H04N 5/3745

(52) U.S. Cl. CPC H04N 5/37457; H04N 5/37455

(57) ABSTRACT

An image sensor comprises a plurality of image pixel circuits arranged in an array; image processing circuitry including a sample-and-hold circuit configured to receive a first reference voltage and an analog-to-digital converter configured to receive a second reference voltage; and a reference adjustment circuit configured to selectively adjust the first reference voltage and/or the second reference voltage, thereby to match an operating range of the sample-and-hold circuit with an operating range of the analog-to-digital converter, based on a measurement signal.

### BACKGROUND OF THE INVENTION

### 1. Field of the Invention

This application relates generally to image sensors. More specifically, this application relates to the adjustment and matching of an operating voltage between a sample-and hold circuit and an analog-to-digital converter.

### 2. Description of Related Art

Image sensing devices typically consist of an image sensor, generally an array of pixel circuits, as well as signal processing circuitry and any associated control or timing circuitry. Within the image sensor itself, charge is collected in a photoelectric conversion device of the pixel circuit as a result of the impingement of light and an electrical signal is generated therefrom. The electrical signal is routed through a collection of analog readout circuits, which may comprise signal amplifiers, signal condition circuits, vertical signal lines (VSLs), sample and hold (S/H) circuits, and analog-to-digital converters (ADCs). Among other operations, the signals from the VSLs are sampled and then converted into digital values by ADCs.

In the image sensor, the S/H circuits and the ADCs receive a respective reference voltage. It is important that the reference voltage value for each component be appropriately selected so that the circuit can operate correctly; e.g., without clipping that would distort the signal. For the S/H circuits, the reference voltage value should be selected in relation to the possible range of voltages at the VSL. For the ADCs, the reference voltage value should be selected in relation to the possible voltage ranges from the output of the S/H circuits.

In a practical image sensor, the values required for both reference voltages may not be the same. Furthermore, the voltages may fluctuate randomly as a result of temperature change, process corners, and the like. For optimum operation of the image sensor, it is necessary to monitor the image sensor circuits and dynamically adjust the reference voltages so that the circuits can operate in a manner so as to produce optimum results.

### BRIEF SUMMARY OF THE INVENTION

Various aspects of the present disclosure relate to processing pixels of an image sensor with high accuracy and high throughput.

In one exemplary aspect of the present disclosure, there is provided an image sensor comprising a plurality of image pixel circuits arranged in an array; image processing circuitry including a sample-and-hold circuit configured to receive a first reference voltage and an analog-to-digital converter configured to receive a second reference voltage; and a reference adjustment circuit configured to selectively adjust the first reference voltage and/or the second reference voltage, thereby to match an operating range of the sample-and-hold circuit with an operating range of the analog-to-digital converter, based on a measurement signal.

In another exemplary aspect of the present disclosure, there is provided a method of operating an image sensor that comprises a plurality of image pixel circuits arranged in an array, image processing circuitry including a sample-and-hold circuit and an analog-to-digital converter, and a reference adjustment circuit, the method comprising receiving, by the sample-and-hold circuit, a first reference voltage; receiving, by the analog-to-digital converter, a second reference voltage; and selectively adjusting, by the reference adjustment circuit, the first reference voltage and/or the second reference voltage, thereby to match an operating range of the sample-and-hold circuit with an operating range of the analog-to-digital converter, based on a measurement signal.

In another exemplary aspect of the present disclosure, there is provided an image sensor comprising a plurality of image pixel circuits arranged in a first array having M rows and N₁ columns, wherein M and N₁ are positive integers; a plurality of dummy pixel circuits arranged in a second array having M rows and N₂ columns, wherein N₂ is a positive integer; image processing circuitry including a sample-and-hold circuit configured to receive a first reference voltage and an analog-to-digital converter configured to receive a second reference voltage; and a reference adjustment circuit configured to selectively adjust the first reference voltage and/or the second reference voltage, thereby to match an operating range of the sample-and-hold circuit with an operating range of the analog-to-digital converter, based on a measurement signal.

In this manner, various aspects of the present disclosure provide for improvements in at least the technical fields of imaging and image processing.

This disclosure can be embodied in various forms, including hardware or circuits controlled by computer-implemented methods, computer program products, computer systems and networks, user interfaces, and application programming interfaces; as well as hardware-implemented methods, signal processing circuits, image sensor circuits, application specific integrated circuits, field programmable gate arrays, and the like. The foregoing summary is intended solely to give a general idea of various aspects of the present disclosure, and does not limit the scope of the disclosure in any way.

### DESCRIPTION OF THE DRAWINGS

These and other more detailed and specific features of various embodiments are more fully disclosed in the following description, reference being had to the accompanying drawings, in which:

FIG. 1 illustrates an exemplary image sensor according to various aspects of the present disclosure;

FIG. 2 illustrates an exemplary pixel circuit according to various aspects of the present disclosure;

FIG. 3 illustrates an exemplary bottom plate sampling S/H circuit according to various aspects of the present disclosure;

FIG. 4 illustrates an exemplary signal timing diagram of the exemplary S/H circuit according to FIG. 3;

FIGS. 5A, 5B, and 5C illustrate various operating states of the S/H circuit according to FIG. 3;

FIG. 6 illustrates an exemplary partial circuit diagram according to various aspects of the present disclosure;

FIG. 7A illustrates an exemplary pixel voltage sampling circuit according to various aspects of the present disclosure;

FIG. 7B illustrates an exemplary ADC according to various aspects of the present disclosure;

FIG. 8 illustrates two exemplary voltage operating range shifts according to various aspects of the present disclosure;

FIG. 9 illustrates a block diagram of an exemplary image sensor including a monitor circuit according to various aspects of the present disclosure;

FIGS. 10A and 10B illustrate an exemplary two-sided correction circuit according to various aspects of the present disclosure;

FIGS. 11A and 11B illustrate an operating state of the correction circuit according to FIGS. 10A and 10B;

FIGS. 12A and 12B illustrate another operating state of the correction circuit according to FIGS. 10A and 10B; and

FIGS. 13A and 13B illustrate another exemplary two-sided correction circuit according to various aspects of the present disclosure.

### DETAILED DESCRIPTION

In the following description, numerous details are set forth, such as circuit configurations, waveform timings, circuit operations, and the like, in order to provide an understanding of one or more aspects of the present invention. It will be readily apparent to one skilled in the art that these specific details are merely exemplary and not intended to limit the scope of this application.

Moreover, while the present disclosure focuses mainly on examples in which the various circuits are used in image sensors, it will be understood that this is merely one example of an implementation. It will further be understood that the disclosed circuits can be used in any device in which there is a need to sample a signal and/or convert an analog signal to a digital signal; for example, an audio signal processing circuit, an industrial measurement and control circuit, a memory array, and so on.

[Image Sensor]

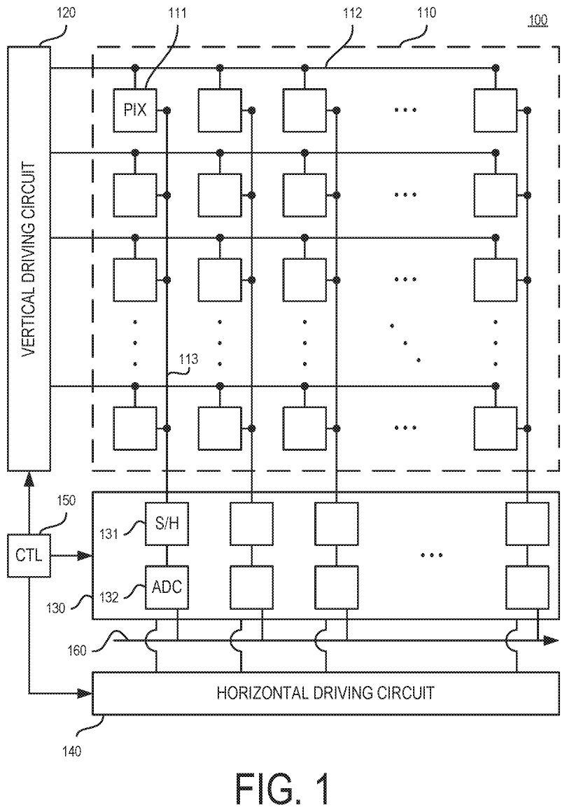

FIG. 1 illustrates an image sensor 100. The image sensor 10 includes a rectangular array 110 of M×N pixel circuits 111, where M and N are positive integers. The pixel circuits 111 are located at intersections where horizontal signal lines 112 and VSLs 113 cross one another. The horizontal signal lines 112 are operatively connected to a vertical driving circuit 120, also known as a “row scanning circuit,” at a point outside of the pixel array 110, and carry signals from the vertical driving circuit 120 to a particular row of the pixel circuits 111. Pixels in a particular column output an analog signal corresponding to an amount of incident light to the VSL 113. For illustration purposes, only a subset of the pixel circuits 110 are actually shown in FIG. 1; however, in practice the image sensor 100 may have up to tens of millions of pixel circuits (“megapixels” or MP) or more.

The VSL 113 conducts the analog signal for a particular column to a column circuit 130, also known as a “signal processing circuit.” A row selection switch may connect the VSL 113 to the column circuit 130. While FIG. 1 illustrates one VSL 113 for each column in the pixel array 110, the present disclosure is not so limited. For example, more than one VSL 113 may be provided for each column, or each VSL 113 may correspond to more than one column. Moreover, while FIG. 1 illustrates a single column circuit 130 for all columns, the image sensor 10 may utilize a plurality of column circuits 130. The analog electrical signal generated in the pixel circuit 111 is retrieved by the column circuit 130 and is then converted to a digital value. Such a conversion typically requires several circuit components such as S/H circuits 131, ADCs 132, and timing and control circuits, with each circuit component serving a purpose in the conversion. For example, the purpose of the S/H circuit 131 may be to sample the analog signals from different time phases of the photodiode operation, after which the analog signals may be converted to digital form by the ADC 132. Furthermore, while FIG. 1 illustrates a single S/H circuit 131 and a single ADC for a column of the pixel circuit 111, other ADC architectures are possible within the context of the present disclosure. These architectures include multiple ADCs for each column, a single ADC for multiple columns, an ADC for a sub-region (e.g. K×L pixel circuits 111 where K and L are positive integers smaller than M and N, respectively), and the like.

The column circuit 130 may be capable of performing the method of correlated double sampling (CDS). CDS is capable of overcoming some pixel noise related issues by sampling each pixel circuit 111 twice. First, the reset voltage Vᵣₑₛₑₜ of a pixel circuit 111 is sampled. This may also be referred to as the P-phase value or cds value. Subsequently, the data voltage V_{data} of the pixel circuit 111 (that is, the voltage after the pixel circuit 111 has been exposed to light) is sampled. This may also be referred to as the D-phase value or light-exposed value. The reset value Vᵣₑₛₑₜ is then subtracted from the data value V_{data} to provide a value which reflects the amount of light falling on the pixel circuit 111.

The column circuit 130 is controlled by a horizontal driving circuit 140, also known as a “column scanning circuit.” Each of the vertical driving circuit 120, the column circuit 130, and the horizontal driving circuit 140 receive one or more clock signals from a controller 150. The controller 150 controls the timing and operation of various image sensor components such that analog signals from the pixel array 110, having been converted to digital signals in the column circuit 130, are output via an output circuit 160 for signal processing, storage, transmission, and the like.

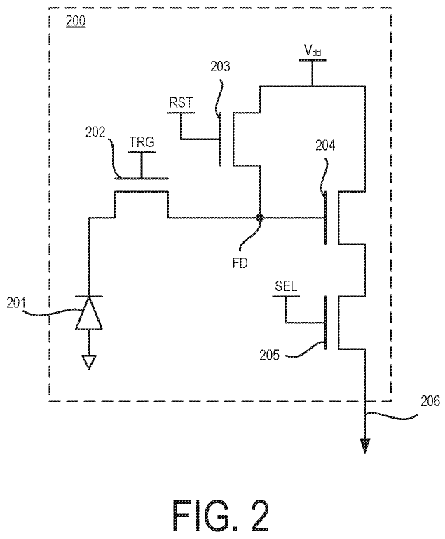

FIG. 2 illustrates an exemplary pixel circuit 200 according to various aspects of the present disclosure. The pixel circuit 200 may be implemented in an image sensor such as the image sensor 100 described above; that is, the pixel circuit 200 may be the pixel circuit 110. As shown in FIG. 2, the pixel circuit 200 includes a photoelectric conversion device 201 (for example, a photodiode), a floating diffusion FD, a transfer transistor 202, a reset transistor 203, an amplification transistor 204, a selection transistor 205, and a VSL 206. The VSL 206 may be common to a plurality of pixel circuits within the same column. Alternatively, the VSL 206 may be shared among multiple columns. Gate electrodes of the transfer transistor 202, the reset transistor 203, and the selection transistor 205 receive signals TRG, RST, and SEL, respectively. These signals may, for example, be provided by the control or timing circuitry. Light falling on the photoelectric conversion device 201 is converted into an analog electrical signal that is output via the VSL 206.

While FIG. 2 illustrates a pixel circuit 200 having four transistors in a particular configuration, the present disclosure is not so limited and may apply to a pixel circuit having fewer or more transistors as well as other elements, such as capacitors, resistors, and the like. Moreover, while FIG. 1 illustrates the amplification transistor 215 disposed between the selection transistor 216 and a power supply voltage V_{dd}, the selection transistor 216 may instead be disposed between the amplification transistor 216 and the power supply voltage V_{dd}. Additionally, the present disclosure may be extended to configurations where one or more transistors are shared among multiple photoelectric conversion devices.

[Column Circuit]

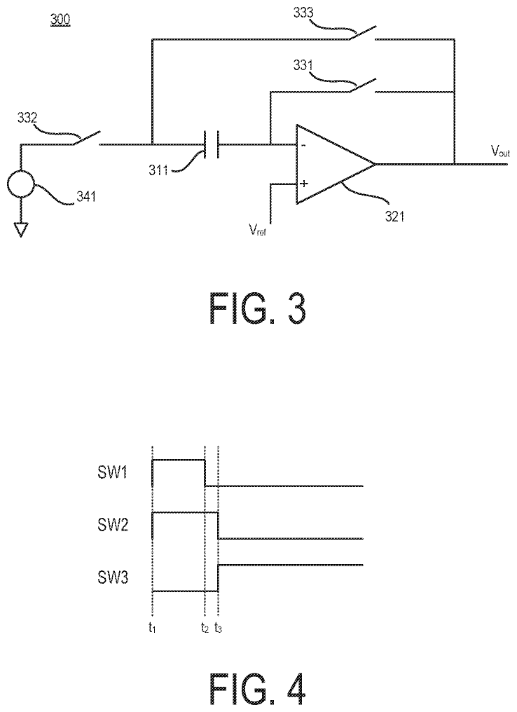

FIG. 3 illustrates an exemplary analog S/H circuit 300 of a bottom plate sampling type. The S/H circuit 300 may be implemented in an image sensor such as the image sensor 100 described above; that is, the S/H circuit 300 may be the S/H circuit 131. The S/H circuit 300 comprises a sampling capacitor 311, an amplifier 321, switches 331, 332, and 333, and an input voltage source 341. V_{ref} is a reference voltage and the voltage source 341 is the input analog voltage (that is, the input signal) to be sampled. The S/H circuit 300 outputs an output voltage Vₒᵤₜ. In an implementation corresponding to the image sensor 100, the voltage source 341 represents the voltage from the pixel circuit 111 via the VSL 113. The switches 331-333 are preferably transistors, such as CMOS transistors.

In operation, the switches 331-333 are controlled according to a particular timing. FIG. 4 illustrates an exemplary timing diagram for the operation of the S/H circuit 300 in which the switch 331 is controlled by a control signal SW1, the switch 332 is controlled by a control signal SW2, and the switch 333 is controlled by a control signal SW3. In FIG. 4, for purposes of illustration, “high” signals indicate “closed” switches and “low” signals indicate “open” switches.

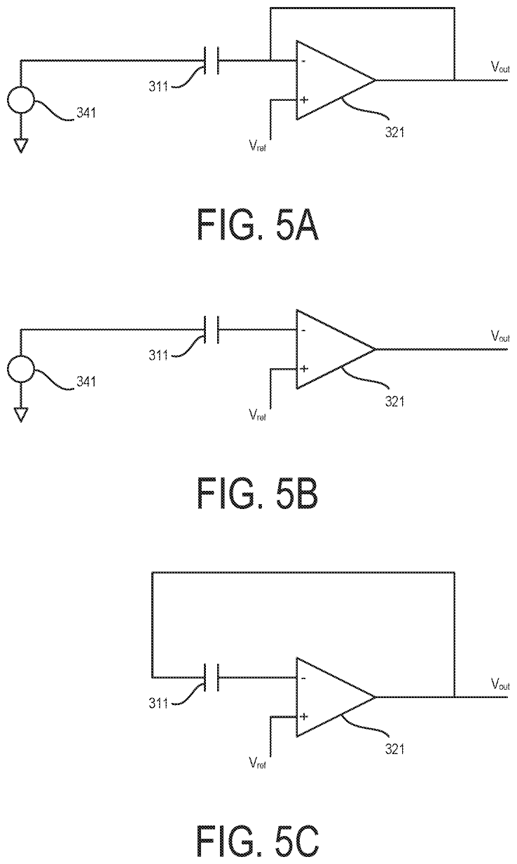

At the beginning of the illustrated period, time t₁, the voltage Vᵢₙ from the voltage source 341 is sampled. That is, the switches 331 and 332 are closed, whereas the switch 333 is open. This configuration is illustrated in FIG. 5A. This configuration causes the sampling capacitor 311 to be charged to the voltage Vᵢₙ−V_{ref}. After the sampling capacitor 311 has been charged, at time t₂, the switch 331 is opened, while the switch 332 remains closed and the switch 333 remains open. This configuration is illustrated in FIG. 5B. This configuration completes the sampling. Then, at time t₃, the switches 332 and 333 are reversed. That is, while the switch 331 remains open, the switch 332 becomes open and the switch 333 becomes closed. This configuration is illustrated in FIG. 5C. Assuming the input resistance and gain of the amplifier is infinite, the voltage on the sampling capacitor 311 and the feedback connection on the amplifier 321 causes the sampled signal Vᵢₙ to appear as the output voltage Vₒᵤₜ.

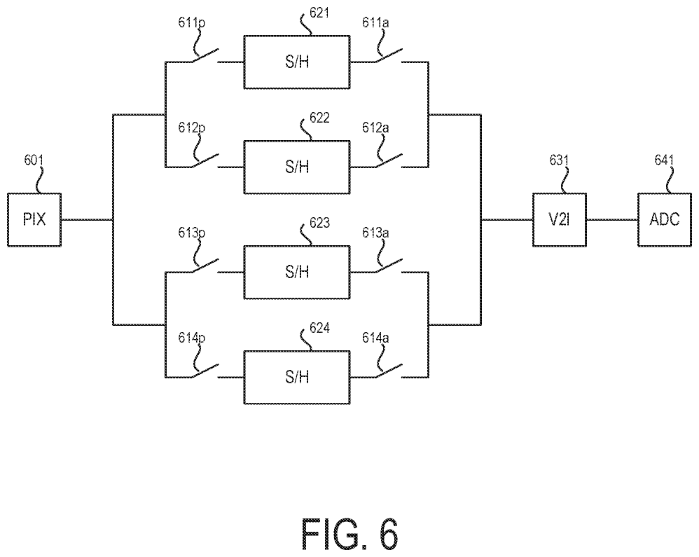

FIG. 6 illustrates a partial circuit diagram including a pixel circuit 601, a set of four S/H circuit 621-624, a voltage-to-current (V2I) circuit 631, and an ADC 641. A first set of four switches 611p-614p are disposed prior to the set of S/H circuits 621-624, and a second set of four switches 611a-614a are disposed after the set of S/H circuits 621-624. The pixel circuit 601 and the set of S/H circuits 621-624 may be implemented in an image sensor such as the image sensor 100 described above; that is, the pixel circuit 601 may be the pixel circuit 111 and/or 200 and the set of S/H circuits 621-624 may collectively represent the S/H circuit 131.

The first set of switches 611p-614p and the second set of switches 611a-614a are operated alternately in timing. In other words, during a first timing interval the first set of switches 611p-614p are closed and the second set of switches 611a-614a are open. During this interval, the set of S/H circuits 621-624 are connected to the pixel circuit 601. During a second timing interval the first set of switches 611p-614p are open and the second set of switches 611a-614a are closed. During this interval, the set of S/H circuits 621-624 are connected to the ADC 641 via the V2I circuit 631. The first and second timing intervals alternate; thus, the set of S/H circuits 621-624 are connected either to the pixel circuit 601 or to the ADC 641 in an alternating-timing manner.

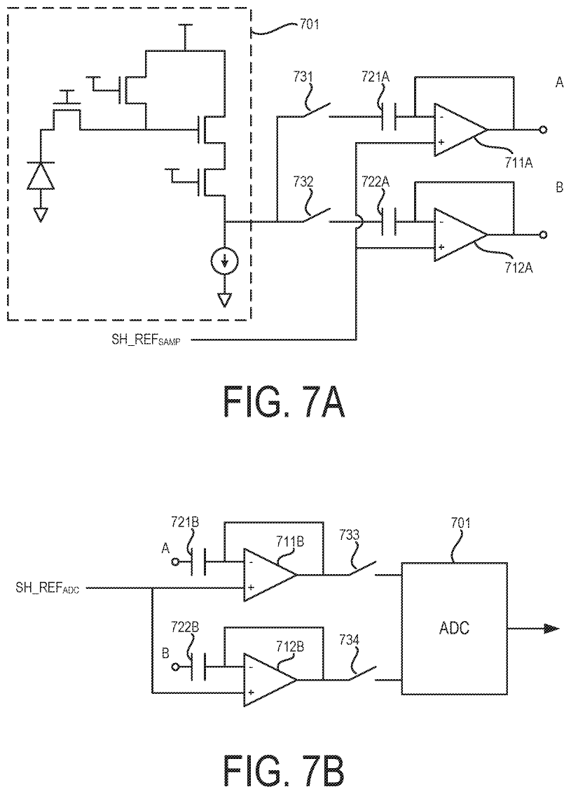

FIG. 7A illustrates an exemplary pixel voltage sampling configuration which includes a pixel circuit 701 and two S/H circuits. The pixel circuit 701 and the S/H circuits may be implemented in an image sensor such as the image sensor 100 described above; that is, the pixel circuit 701 may be the pixel circuit 111 and/or 200 and each S/H circuit may be the S/H circuit 131 and/or 300. The S/H circuits are illustrated in a simplified form as compared to the S/H circuit 131 and/or 300, such that only one switch per S/H circuit is shown. In practice, each S/H circuit of FIG. 7A may include all three switches as illustrated in FIG. 3. As illustrated, a first S/H circuit includes a first amplifier 711A, a first sampling capacitor 721A, and a first switch 731. A second S/H circuit includes a second amplifier 712A, a second sampling capacitor 722A, and a second switch 723. Both S/H circuits receive an analog input voltage from the pixel circuit 701 via a VSL and provide a steady voltage level for a subsequent ADC, which will be described in more detail below. To effect CDS, one of the S/H circuits is configured to sample the P-phase signal from the pixel circuit 701 and the other of the S/H circuits is configured to sample the D-phase signal from the pixel circuit 701.

The negative input of the first amplifier 712A and the second amplifier 712A receive either the P-phase signal (reset level) or the D-phase signal (signal level) from the VSL via the first switch 731 and the second switch 732, respectively, according to a particular timing so as to perform CDS. When the first and second amplifiers 711A and 712A are connected to the pixels by closing the first and second switches 731 and 732, and the first and second amplifiers 711A and 712A are disconnected from the subsequent ADC, the positive input of the first amplifier 712A and the second amplifier 722A receive a reference voltage SH_REF_{SAMP}. The first S/H circuit outputs a signal at an output terminal A and the second S/H circuit outputs a signal at an output terminal B.

FIG. 7B illustrates an exemplary ADC configuration which includes an ADC 701. The ADC 701 may be implemented in an image sensor such as the image sensor 100 described above; that is, the ADC 701 may be the ADC 132. Moreover, the exemplary ADC configuration of FIG. 7B may be used with the exemplary pixel voltage sampling configuration of FIG. 7B, such that the output terminal A of FIG. 7A outputs a signal to an input terminal A of FIG. 7B and the output terminal B of FIG. 7A outputs a signal to an input terminal B of FIG. 7B. A first differential amplifier 711B receives a signal from the input terminal A at a negative input thereof via a first sampling capacitor 721B, and a second differential amplifier 712B receives a signal from the input terminal B at a negative input thereof via a second sampling capacitor 722B.

The first differential amplifier 711B may be the same amplifier as the first amplifier 711A shown in FIG. 7A, and the second differential amplifier 712B may be the same amplifier as the second amplifier 712A shown in FIG. 7A, and thus may be referred to simply as the first amplifier 711 and the second amplifier 712. In this case, when the first and second amplifiers 711 and 712 are disconnected from the pixels by opening the first and second switches 731 and 732, and the first and second amplifiers 711 and 712 are connected to the ADC 701 by closing third and fourth switches 733 and 734, the positive input of the first amplifier 711 and the second differential amplifier 712 receive a reference voltage SH_REF_{ADC}. In other words, the positive inputs of the amplifiers are either connected to the reference voltage SH_REF_{SAMP} or the reference voltage SH_REF_{ADC} depending on whether the amplifiers are connected to the pixels or the ADC.

[Reference Voltage Adjustment]

Because the signal to the input of the S/H circuits of FIG. 6 are received from the pixel circuit 601 via a VSL, the signal level and the reset level depend on the power supply voltage V_{DD} provided to the pixel circuit 601 and on operating characteristics of the pixel transistors included in the pixel circuit 601. Depending on which row of the pixel array is being read, the length of the VSL will be different and hence the IR drop on the VSL will change. Additional factors such as temperature in the image sensor and process corners of the semiconductor fabrication process also influence the various signal levels. Therefore, if a fixed value is used for both SH_REF_{SAMP} and SH_REF_{ADC}, the variations would cause the fixed reference values to be inappropriate for optimum circuit operation and may cause degradation to the performance of the image sensor. To prevent such degradation, it is possible to monitor the pixel values and make corresponding adjustments to the reference voltages so as to maintain the image sensor in an optimum operating condition.

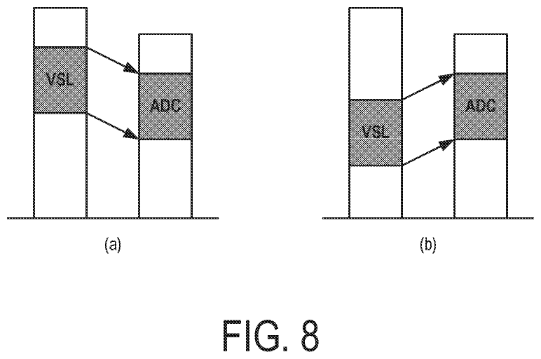

FIG. 8 illustrates two examples of mismatch between the operation of the S/H circuit and the operation of the ADC. In example (a), the VSL voltage operating range (that is, the range input to the S/H circuit) is higher than the ADC voltage operating range. In this example, the reference voltage SH_REF_{SAMP} should be shifted up relative to the reference voltage SH_REF_{ADC} or, equivalently, the reference voltage SH_REF_{ADC} should be shifted down relative to the reference voltage SH_REF_{SAMP}. In example (b), the VSL operating range is lower than the ADC voltage operating range. In this example, the reference voltage SH_REF_{SAMP} should be shifted down relative to the reference voltage SH_REF_{ADC} or, equivalently, the reference voltage SH_REF_{ADC} should be shifted up relative to the reference voltage SH_REF_{SAMP}. Alternatively, it is possible to shift the ADC voltage operating range via adjusting the reference voltage SH_REF_{ADC} to match the VSL operating range. In yet another alternative, it is possible to shift both the VSL voltage operating range and the ADC voltage operating range so that they match each other.

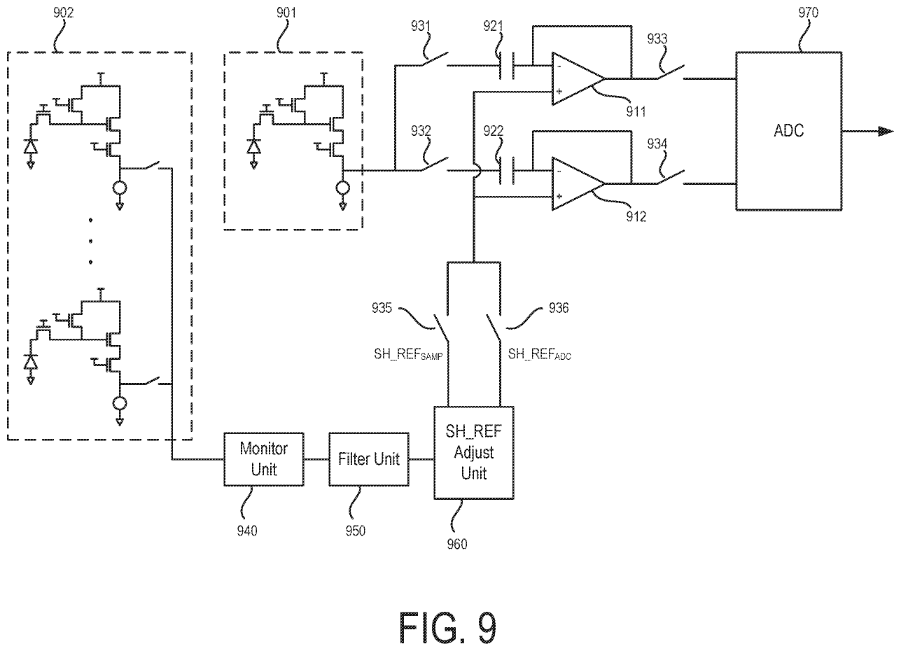

In order to determine how much shift to the voltage operating range is required, it is necessary to monitor the actual voltage level in the circuit. FIG. 9 illustrates an exemplary arrangement for doing so. FIG. 9 illustrates an image pixel circuit 901; a column of dummy pixel circuits 902; a pixel voltage sampling section which includes a first amplifier 911, a second amplifier 912, a first sampling capacitor 921, a second sampling capacitor 922, first through sixth switches 931-936; a correction circuit which includes a monitor unit (such as a monitor circuit) 940 and a filter unit (such as a filter circuit) 950; a SH_REF adjustment unit (such as a SH_REF adjustment circuit) 960; and an ADC 970.

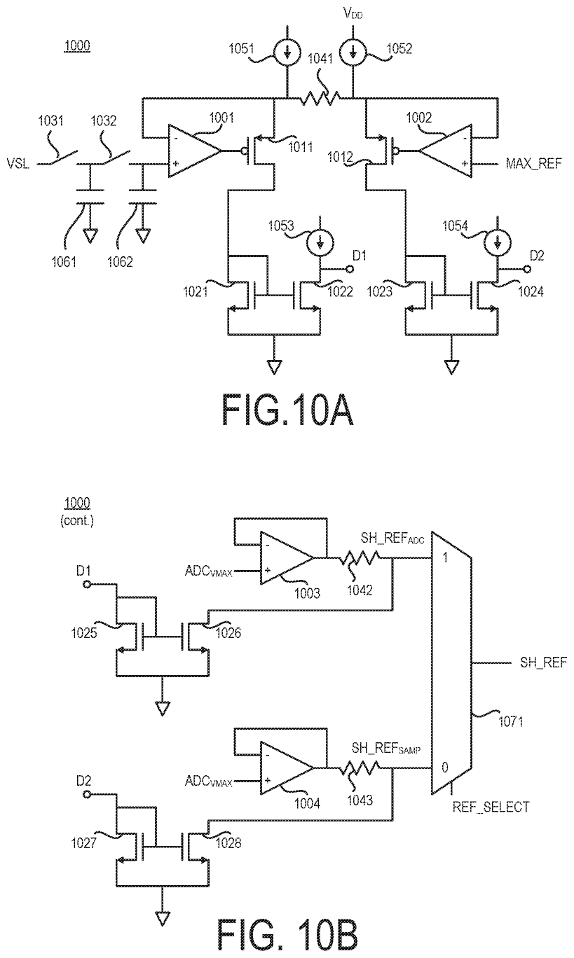

Various circuit elements of FIG. 9 may be implemented in a similar manner to those described above. As such, the image pixel circuit 901 may be the pixel circuit 111, 200, and/or 601; the pixel voltage sampling unit may be the pixel voltage sampling configuration illustrated in FIG. 6, and the ADC unit may be the ADC configuration illustrated in FIG. 7. Moreover, the dummy pixel circuits 902 may be similarly-structured to the image pixel circuit 901 except that the dummy pixel circuits 902 may be located at the outside edge of the pixel array so that they do not receive light and do not interfere with the pixel circuits that are used for image capture. While only one column of the dummy pixel circuits 902 is shown in FIG. 10, in practical implementations multiple columns may be provided. That is, in general the image pixel circuit 901 is part of an M×N₁ array and the dummy pixel circuits 902 are part of an M×N₂ array, where M, N₁, and N₂ are positive integers. In such an implementation the multiple dummy pixel circuits 902 of a given row may be averaged together. This may produce a more robust level as a result of lowering noise. Monitoring by monitor unit 940 is done on a row-by-row basis such that the dummy pixel circuits 902 are read in synchronization with the image pixel circuit 901 of the corresponding row. The monitoring is preferably done during the reset phase of the pixel circuit reading operation so that the reset voltage level is observed.

Because there are various noise sources in the circuit, the output of the monitor unit 940 is provided to the filter unit 950, which is used to smooth out random variations as well as reduce the sensitivity of the measuring circuit to pixel defects. The filter unit 950 may be a recursive low-pass filter. Preferably, the filter unit 950 is reset once per frame, e.g., when the first row in the image sensor is being accessed. Alternatively, the filter may be reset once per several frames or several times within a frame.

The output of the filter unit 950 is used to adjust the reference voltages SH_REF_{SAMP} and SH_REF_{ADC} in the SH_REF adjustment unit 960. When the first and second amplifiers 911 and 912 are connected to the pixel circuit 901 via the first and second switches 931 and 932, which are closed, the reference voltage SH_REF_{SAMP} is connected to the first and second amplifiers 911 and 912 via the fifth switch 935, which is closed. When the first and second amplifiers 911 and 912 are connected to the ADC 970 via the third and fourth switches 933 and 934, which are closed, the reference voltage SH_REF_{ADC} is connected to the first and second amplifiers 911 and 912 via the sixth switch 936, which is closed. The timing of the first and second switches 931 and 932 and the third and fourth switches 933 and 934 alternate; thus, the set of first and second amplifiers 911 and 912 are connected either to the pixel circuit 901 or to the ADC 970 in an alternating-timing manner.

When these reference voltages are changed, the voltage operating range of the corresponding S/H circuit and/or the ADC circuit would change in turn. Adjustments are made in the SH_REF adjustment unit 960 to equalize the voltage operating ranges of the S/H circuit and the ADC circuit.

[First Example of Correction Circuit]

FIGS. 10A-B illustrate a two-sided correction circuit 1000. The two-sided correction circuit 1000 may be implemented in an image sensor such as those described above; that is, the two-sided correction circuit 1000 may be the correction circuit illustrated in FIG. 9 which includes the filter unit 950 and the SH_REF adjustment unit 960. In FIG. 10A, the filter unit is implemented as a recursive low-pass filter which includes switches 1031 and 1032 and capacitors 1061 and 1062. The capacitance value of the capacitor 1062 is larger than the capacitance value of the capacitor 1061. The capacitor 1062 is used to store the filtered voltage value from the dummy pixel circuits. A new value of the signal VSL_{P-ph} is sampled from the dummy pixel circuit (or circuits, if multiple columns of dummy pixel circuits are provided) and stored in the capacitor 1061 when the switch 1031 is closed and the switch 1032 is open. Subsequently, the switch 1031 is opened and the switch 1032 is closed, which causes a charge sharing among the capacitors 1061 and 1062. As such, a weighted average is calculated and the purpose of the recursive low-pass filter is achieved.

FIG. 10A also illustrates a pair of differential amplifiers 1001 and 1002 with a resistor 1041 which provides a voltage-to-current conversion function, and two current mirrors. The resistor 1041 is connected between the negative inputs of the differential amplifiers 1001 and 1002. A first current source 1051 provides an offset current I_{offset} to a node between the negative input of the differential amplifier 1001 and one end of the resistor 1041, and a second current source 1052 provides a power supply current to a node between the negative input of the differential amplifier 1002 and the other end of the resistor 1041. The outputs of the differential amplifiers 1001 and 1002 are provided to gate electrodes of transistors 1011 and 1012, respectively, so as to control the flow of current to the first and second current mirrors. The first current mirror includes transistors 1021 and 1022 and a first mirror current source 1053, and the second current mirror includes transistors 1023 and 1024 and a second mirror current source 1054.

The positive terminals of the differential amplifiers 1001 and 1002 receive a voltage from the recursive low-pass filter and a maximum reference voltage, respectively. The difference between these positive terminals is given by the relation ΔV=MAX_REF−VSL_{P-ph}. This voltage differential causes a differential current to flow in the resistor 1041. According to Ohm's law this current is given by ΔV/R, where R is a resistance value of the resistor 1041. The direction of the current thus depends on the sign of ΔV. The output of the first current mirror is terminal D1 and the output of the second current mirror is terminal D2, which respectively correspond to the inputs at terminal D1 and terminal D2 of FIG. 10B. While the inputs and outputs are illustrated and described as “terminals,” FIGS. 10A-B may illustrate different parts of the same circuit such that the inputs D1 and D2 of FIG. 10B are mere extensions of the outputs D1 and D2 of FIG. 10A.

As illustrated, input D1 is connected to a third current mirror that includes transistors 1025 and 1026 and input D2 is connected to a fourth current mirror that includes transistors 1027 and 1028. The two-sided correction circuit 1000 also includes another pair of differential amplifiers 1003 and 1004, both of which receive a voltage reference ADC_{VMAX} at the positive terminal thereof and both of which have a feedback loop such that the output thereof is connected to the negative terminal thereof. The output of the differential amplifier 1003, the signal SH_REF_{ADC}, passes through a resistor 1042 and, at a subsequent node, the output of the third current mirror is connected. The output of the differential amplifier 1004, the signal SH_REF_{SAMP}, passes through a resistor 1043 and, at a subsequent node, the output of the fourth current mirror is connected. Both of these nodes are connected to different inputs of a multiplexer 1071, the output of which is the signal SH_REF based on a selection signal REF_SELECT. Both the resistor 1042 and the resistor 1043 have a resistance value R, which is the same resistance value as the resistor 1041.

While transistors 1011 and 1012 are illustrated as PMOS transistors and transistors 1021-1028 are illustrated as NMOS transistors, the present disclosure is not so limited. For example, some or all of transistors 1011 and 1012 and 1021-1028 may be of a different conductivity type from that illustrated, so long as the various interconnections and/or control signals are modified accordingly.

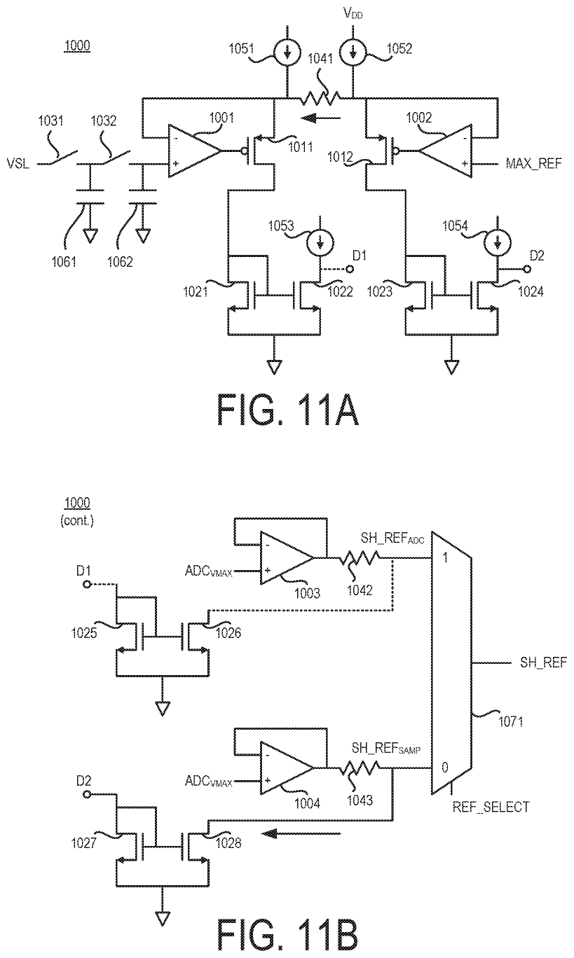

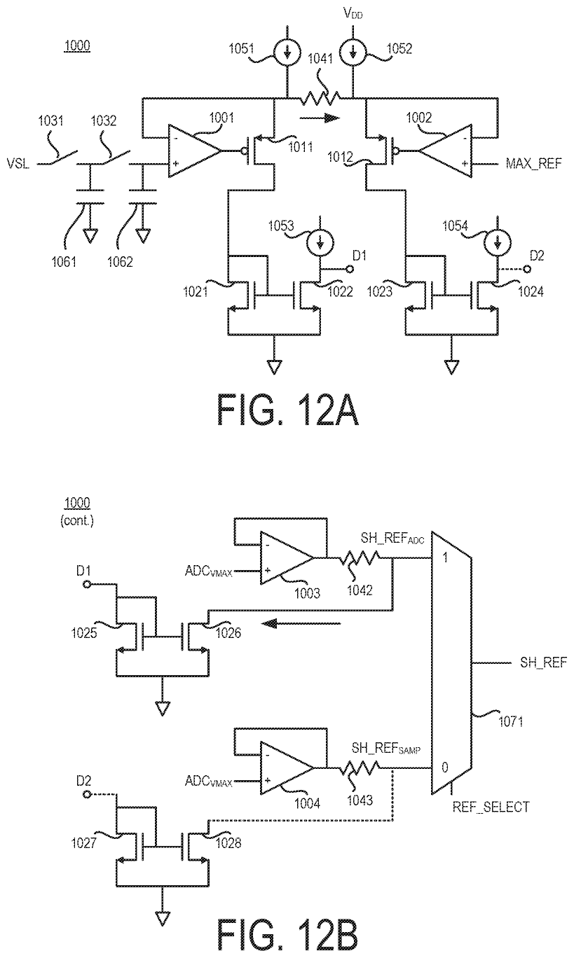

In the two-sided correction circuit 1000 of FIGS. 10A-B, ΔV can be either positive or negative, and SH_REF will never exceed a maximum operating voltage of the ADC, ADC_{VMAX}. FIGS. 11A-B illustrate the two-sided correction circuit 1000 in a case where ΔV is positive (i.e., MAX_REF>VSL_{P-ph}) and FIGS. 12A-B illustrate the two-sided correction circuit 1000 in a case where ΔV is negative (i.e., MAX_REF<VSL_{P-ph}).

In the case where ΔV is positive illustrated in FIGS. 11A-B, the current flowing through the drain of the transistor 1021 is given by the relation I₁₀₂₁=I_{offset}+ΔV/R. Because the transistors 1021 and 1022 are part of the first current mirror, a similar (mirrored) current I_{offset}+ΔV/R would ideally flow through the transistor 1022. This would require a current of magnitude ΔV/R to flow from the transistor 1025 to the transistor 1022. However, this is not possible due to the polarity and bias of the transistor 1025. Because the transistors 1025 and 1026 are part of the third current mirror, the current through the transistor 1026 is also zero. This is the equivalent of disconnecting the current path at the node D1, which is illustrated by the dashed line in FIGS. 11A-B. As such, zero current flows through the resistor 1042 and the reference voltage SH_REF_{ADC} remains at the level ADC_{VMAX}.

Furthermore, the current flowing to the drain of the transistor 1023 is given by the relation I₁₀₂₃=I_{offset}−ΔV/R. This causes a mirrored current to flow through the transistor 1024; thus, a current of magnitude ΔV/R will flow from the drain of the transistor 1024 to the transistor 1027 via the node D2. Because the transistors 1027 and 1028 are part of the fourth current mirror, a current of magnitude ΔV/R will flow through the resistor 1043, which controls the level of the reference voltage SH_REF_{SAMP}. As illustrated in FIGS. 11A-B, this level is given by the relation SH_REF_{SAMP}=ADC_{VMAX}−(ΔV/R)×R=ADC_{VMAX}−ΔV.

Thus, as illustrated in FIGS. 11A-B, the case of a positive ΔV results in SH_REF_{ADC} being unchanged while SH_REF_{SAMP} is shifted down by ΔV; that is, there is a net voltage difference of ΔV where SH_REF_{ADC} is at a higher level. This corresponds to example (b) illustrated in FIG. 8.

In the case where ΔV is negative, illustrated in FIGS. 12A-B, the current flowing through the drain of the transistor 1021 is still given by the relation I₁₀₂₁=I_{offset}+ΔV/R. Because the ΔV is negative, however, a current −ΔV/R flows to the transistor 1025 so that the current in the transistor 1022 mirrors the current in the transistor 1021. Because the transistors 1025 and 1026 are part of the third current mirror, the current to the drain of the transistor 1026 is also −ΔV/R. This causes a voltage drop in the resistor 1042, which controls the level of the reference voltage SH_REF_{ADC}. As illustrated in FIGS. 12A-B, this level is given by the relation SH_REF_{ADC}=ADC_{VMAX}−(−ΔV/R)×R=ADC_{VMAX}+ΔV.

Furthermore, because the transistors 1023 and 1024 are part of the second current mirror, a mirrored current would ideally flow through the transistor 1024. In this case, however, such a current flow is not possible due to the polarity and bias of the transistor 1027. Because the transistors 1027 and 1028 are part of the fourth current mirror, the current through the transistor 1028 is also zero. This is the equivalent of disconnecting the current path at the node D2, which is illustrated by the dashed line in FIGS. 12A-B. As such, zero current flows through the resistor 1043 and the reference voltage SH_REF_{SAMP} remains at the level ADC_{VMAX}.

Thus, as illustrated in FIGS. 12A-B, the case of a negative ΔV results in SH_REF_{ADC} being shifted down by ΔV while SH_REF_{SAMP} is unchanged; that is, there is a net voltage difference of ΔV where SH_REF_{SAMP} is at a higher level. This corresponds to example (b) illustrated in FIG. 8.

[Second Example of Correction Circuit]

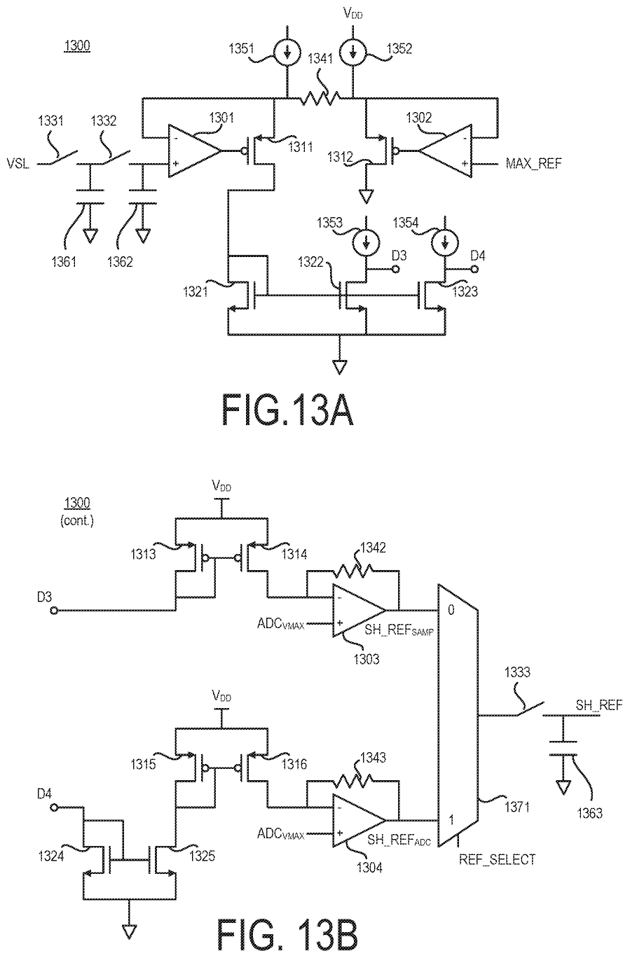

FIGS. 13A-B illustrate a two-sided correction circuit 1300. The two-sided correction circuit 1300 may be implemented in an image sensor such as those described above as an alternative to the two-sided correction circuit 1000; that is, the two-sided correction circuit 1000 may be the correction circuit illustrated in FIG. 9 which includes the filter unit 950 and the SH_REF adjustment unit 960. In FIG. 13A, the filter unit is implemented as a recursive low-pass filter which includes switches 1331 and 1332 and capacitors 1361 and 1362. The capacitance value of the capacitor 1362 is larger than the capacitance value of the capacitor 1361. The capacitor 1362 is used to store the filtered voltage value from the dummy pixel circuits. A new value of the signal VSL_{P-ph} is sampled from the dummy pixel circuit (or circuits, if multiple columns of dummy pixel circuits are provided) and stored in the capacitor 1361 when the switch 1331 is closed and the switch 1332 is open. Subsequently, the switch 1331 is opened and the switch 1332 is closed, which causes a charge sharing among the capacitors 1361 and 1362. As such, a weighted average is calculated and the purpose of the recursive low-pass filter is achieved.

FIG. 13A also illustrates a pair of differential amplifiers 1301 and 1302 with a resistor 1341 having a resistance value R and which provides a voltage-to-current conversion function, and two current mirrors. The resistor 1341 is connected between the negative inputs of the differential amplifiers 1301 and 1302. A first current source 1351 provides an offset current I_{offset} to a node between the negative input of the differential amplifier 1301 and one end of the resistor 1341, and a second current source 1352 provides a power supply current to a node between the negative input of the differential amplifier 1302 and the other end of the resistor 1341. The outputs of the differential amplifiers 1301 and 1302 are provided to gate electrodes of transistors 1311 and 1312, respectively, so as to control the flow of current to the current mirrors. A transistor 1321 forms a first current mirror with a transistor 1322 plus a first mirror current source 1353, and forms a second current mirror with a transistor 1323 plus a second current mirror source 1354. The output of the first current mirror is terminal D3 and the output of the second current mirror is terminal D4, which respectively correspond to the inputs at terminal D3 and terminal D4 of FIG. 13B. While the inputs and outputs are illustrated and described as “terminals,” FIGS. 13A-B may illustrate different parts of the same circuit such that the inputs D3 and D4 of FIG. 13B are mere extensions of the outputs D3 and D4 of FIG. 13A.

As illustrated, input D3 is connected to a third current mirror that includes transistors 1313 and 1314 and input D4 is connected to a fourth current mirror that includes transistors 1324 and 1325 and to a fifth current mirror that includes transistors 1315 and 1316. The two-sided correction circuit 1300 also includes another pair of differential amplifiers 1303 and 1304, both of which receive a voltage reference ADC_{VMAX} at the positive terminal thereof. The negative terminal of the differential amplifier 1303 receives an output of the third current mirror, includes a feedback loop which includes a resistor 1342, and outputs a signal SH_REF_{SAMP}. The negative terminal of the differential amplifier 1304 receives an output of the fifth current mirror, includes a feedback loop which includes a resistor 1343, and outputs a signal SH_REF_{ADC}. Both the resistor 1342 and the resistor 1343 have a resistance value R, which is the same resistance value as the resistor 1341. The signals SH_REF_{SAMP} and SH_REF_{ADC} are output to different inputs of a multiplexer 1371, the output of which is the signal SH_REF based on a selection signal REF_SELECT. The output of the multiplexer 1371 is connected to the output of the two-sided correction circuit via a switch 1333 and is capacitively coupled to ground via a capacitor 1363.

While transistors 1311-1316 are illustrated as PMOS transistors and transistors 1321-1325 are illustrated as NMOS transistors, the present disclosure is not so limited. For example, some or all of transistors 1311-1316 and 1321-1325 may be of a different conductivity type from that illustrated, so long as the various interconnections and/or control signals are modified accordingly.

In the two-sided correction circuit 1300 of FIGS. 13A-B, ΔV can be either positive or negative, and SH_REF will never exceed a maximum operating voltage of the ADC, ADC_{VMAX}. In the case where ΔV is positive, the first current mirror causes a current I=ΔV/R to flow from the transistor 1313 to the transistor 1322. As a result, the current in the transistor 1314 is also I=ΔV/R and the resistor 1342 causes a voltage drop. As a result, the output of the differential amplifier 1303 is given by the relation SH_REF_{SAMP}=ADC_{VMAX}−(ΔV/R)×R=ADC_{VMAX}−ΔV. Because of the polarity and bias of the transistor 1324, a current cannot flow from the transistor 1324 to the transistor 1323, which means that no mirrored current flows in the transistors 1325, 1315, or 1316. Thus, SH_REF_{ADC} is maintained at the level ADC_{VMAX}. In other words, the case of a positive ΔV results in SH_REF_{ADC} being unchanged while SH_REF_{SAMP} is shifted down by ΔV; that is, there is a net voltage difference of ΔV where SH_REF_{ADC} is at a higher level. This corresponds to example (b) illustrated in FIG. 8.

In the case where ΔV is negative, the polarity and bias of the transistor 1313 prevents the flow of current from the transistor 1322 to the transistor 1313, which means that no mirrored current flows in the transistor 1314. Thus, SH_{_SAMP} is maintained at the level ADC_{VMAX}. The second current mirror, however, causes a current I=−ΔV/R to flow from the transistor 1323 to the transistor 1324. As a result, the mirrored currents in the transistors 1325, 1315, and 1316 are also I=−ΔV/R and the resistor 13423 causes a voltage drop. As a result, the output of the differential amplifier 1304 is given by the relation SH_REF_{SAMP}=ADC_{VMAX}−(−ΔV/R)×R=ADC_{VMAX}+ΔV. Thus, the case of a negative ΔV results in SH_REF_{ADC} being shifted down by ΔV while SH_REF_{SAMP} is unchanged; that is, there is a net voltage difference of ΔV where SH_REF_{SAMP} is at a higher level. This corresponds to example (b) illustrated in FIG. 8.

### CONCLUSION

With regard to the processes, systems, methods, heuristics, etc. described herein, it should be understood that, although the steps of such processes, etc. have been described as occurring according to a certain ordered sequence, such processes could be practiced with the described steps performed in an order other than the order described herein. It further should be understood that certain steps could be performed simultaneously, that other steps could be added, or that certain steps described herein could be omitted. In other words, the descriptions of processes herein are provided for the purpose of illustrating certain embodiments, and should in no way be construed so as to limit the claims.

Accordingly, it is to be understood that the above description is intended to be illustrative and not restrictive. Many embodiments and applications other than the examples provided would be apparent upon reading the above description. The scope should be determined, not with reference to the above description, but should instead be determined with reference to the appended claims, along with the full scope of equivalents to which such claims are entitled. It is anticipated and intended that future developments will occur in the technologies discussed herein, and that the disclosed systems and methods will be incorporated into such future embodiments. In sum, it should be understood that the application is capable of modification and variation.

All terms used in the claims are intended to be given their broadest reasonable constructions and their ordinary meanings as understood by those knowledgeable in the technologies described herein unless an explicit indication to the contrary in made herein. In particular, use of the singular articles such as “a,” “the,” “said,” etc. should be read to recite one or more of the indicated elements unless a claim recites an explicit limitation to the contrary.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. An image sensor, comprising:
a plurality of image pixel circuits arranged in an array;
image processing circuitry including a sample-and-hold circuit configured to receive a first reference voltage and an analog-to-digital converter configured to receive a second reference voltage; and
a reference adjustment circuit configured to selectively adjust the first reference voltage and/or the second reference voltage, thereby to match an operating range of the sample-and-hold circuit with an operating range of the analog-to-digital converter, based on a measurement signal.

2. The image sensor according to claim 1, further comprising:
a plurality of dummy pixel circuits; and
monitor circuitry configured to monitor a reset level of at least one of the plurality of dummy pixel circuits and to output the measurement signal to the reference adjustment circuit.

3. The image sensor according to claim 1, wherein the reference adjustment circuit includes filter circuitry configured to receive the measurement signal and output a filtered signal.

4. The image sensor according to claim 3, wherein the filter circuitry is a recursive low-pass filter.

5. The image sensor according to claim 1, wherein the reference adjustment circuit includes voltage-to-current conversion circuitry configured to receive a voltage differential and output a differential current.

6. The image sensor according to claim 5, wherein the reference adjustment circuit includes a current mirror configured to receive the differential current and output a mirrored current.

7. The image sensor according to claim 6, wherein the reference adjustment circuit includes a differential amplifier configured to adjust the first reference voltage or the second reference voltage in response to the mirrored current.

8. The image sensor according to claim 1, wherein the reference adjustment circuit includes voltage-to-current conversion circuitry to:
receive a voltage differential,
in a first case where the voltage differential is positive, output a first differential current to a first current mirror, and
in a second case where the voltage differential is negative, output a second differential current to a second current mirror.

9. An electronic device including the image sensor according to claim 1.

10. A method of operating an image sensor that comprises a plurality of image pixel circuits arranged in an array, image processing circuitry including a sample-and-hold circuit and an analog-to-digital converter, and a reference adjustment circuit, the method comprising:
receiving, by the sample-and-hold circuit, a first reference voltage;
receiving, by the analog-to-digital converter, a second reference voltage; and
selectively adjusting, by the reference adjustment circuit, the first reference voltage and/or the second reference voltage, thereby to match an operating range of the sample-and-hold circuit with an operating range of the analog-to-digital converter, based on a measurement signal.

11. The method according to claim 10, wherein
the image sensor further comprises a plurality of dummy pixel circuits and monitor circuitry, and
the method further comprises monitoring, by the monitor circuitry, a reset level of at least one of the plurality of dummy pixel circuits and outputting the measurement signal to the reference adjustment circuit.

12. The method according to claim 10, further comprising:
receiving, by filter circuitry included in the reference adjustment circuit, the measurement signal, and
outputting, by the filter circuitry, a filtered signal.

13. The method according to claim 12, wherein the filter circuitry is a recursive low-pass filter.

14. The method according to claim 10, further comprising:
receiving, by voltage-to-current conversion circuitry included in the reference adjustment circuit, a voltage differential, and
outputting, by the voltage-to-current conversion circuitry, a differential current.

15. The method according to claim 14, further comprising:
receiving, by a current mirror included in the reference adjustment circuit, the differential current, and
outputting, by the current mirror, a mirrored current.

16. The method according to claim 15, further comprising:
adjusting, by a differential amplifier included in the reference adjustment circuit and in response to the mirrored current, the first reference voltage or the second reference voltage.

17. The method according to claim 10, further comprising:
receiving, by voltage-to-current conversion circuitry included in the reference adjustment circuit, a voltage differential, and
in a first case where the voltage differential is positive, outputting, by the voltage-to-current conversion circuitry, a first differential current to a first current mirror, and
in a second case where the voltage differential is negative, outputting, by the voltage-to-current conversion circuitry, a second differential current to a second current mirror.

18. An image sensor, comprising:
a plurality of image pixel circuits arranged in a first array having M rows and N₁ columns, wherein M and N₁ are positive integers;
a plurality of dummy pixel circuits arranged in a second array having M rows and N₂ columns, wherein N₂ is a positive integer;
image processing circuitry including a sample-and-hold circuit configured to receive a first reference voltage and an analog-to-digital converter configured to receive a second reference voltage; and
a reference adjustment circuit configured to selectively adjust the first reference voltage and/or the second reference voltage, thereby to match an operating range of the sample-and-hold circuit with an operating range of the analog-to-digital converter, based on a measurement signal.

19. The image sensor according to claim 18, wherein the plurality of image pixel circuits and the plurality of dummy pixel circuits are read in synchronization with each other on a row-by-row basis.

20. The image sensor according to claim 18, wherein n₂ is equal to one.
